(19) United States
(12) Patent Application Publication
(10) Pub. No.: US 2008/0033918 A1
(43) Pub. Date: Feb. 7, 2008

(54) Systems, methods and computer program products for supplemental data communication and utilization

(76) Inventors: Jeffrey L. Wilson, Apex, NC (US); Bentley J. Olive, Apex, NC (US)

Correspondence Address: JENKINS, WILSON, TAYLOR & HUNT, P. A., 3100 TOWER BLVD., Suite 1200, DURHAM, NC, 27707, US

(21) Appl. No.: 11/497,844

(22) Filed: Aug. 2, 2006

(51) Int. Cl. G06F 17/30

(52) U.S. Cl. 707/3

(57) ABSTRACT

Systems, methods and computer program products are provided for supplemental data communication and utilization. Supplemental data associated with a user request, such as a search query, can be generated and communicated either invisibly or visibly to the user. In one aspect, the supplemental data can be or include predictive supplemental data that can relate to the user request.

### TECHNICAL FIELD

The presently disclosed subject matter relates generally to data communication, and more particularly to systems, methods and computer program products for supplemental data communication and utilization such as for utilizing communicated data outside of a communication session.

### BACKGROUND

Networks provide for the exchange of data, commands, and command responses between network-enabled devices. For example, the Internet is a wide area network that is used for communicating multimedia data, documents, commands, and command responses. In another example, computers may be connected together in a local area network (LAN) for exchanging data with one another. Typically, network-enabled devices include input and output interfaces that can be used for receiving data for communication over a network from a person and for displaying network-communicated data to a person. Network-enabled devices in a network can be directly connected, indirectly connected, wirelessly connected, and connected by a wire.

Network-enabled devices may establish a communication session between one another for exchanging messages, information, and data. For example, a network-enabled device may be used for communicating a search query to a search engine for retrieving search results. In another example, a network-enabled device may communicate a command to another network-enabled device for monitoring or operating equipment. In this example, the device receiving the command can communicate a response message including monitoring-related information or operating-related information.

One goal with network communications is to communicate data efficiently between network-enabled devices. Exemplary challenges to efficient network communication is that networks have limited bandwidths, network communicated data may be lost or dropped during communication, and receiving network communication device may have insufficient memory for receiving network communicated data or otherwise insufficient resources, peripherals or other components for handling received network communicated data (e.g., insufficient display area for displaying received documents or other data). Further, it is desirable to reduce the number of network communications between network-enabled devices in order to avoid some of the difficulties associated with network communication.

Accordingly, there exists a need for improved systems, methods and computer program products for improved data communication and for utilizing communicated data outside of a communication session.

### SUMMARY

In accordance with the present disclosure, novel systems, methods, and computer program products are provided for supplemental data communication and utilization of communicated data outside of a communication session, as described, for example, in detail below.

### BRIEF DESCRIPTION OF THE DRAWINGS

Preferred embodiments of the subject matter described herein will now be explained with reference to the accompanying drawings of which:

FIG. 1 is a block diagram of an exemplary network including a client device and a client server according to the subject matter described herein;

FIG. 2 is a flow chart of one example of a process for providing command results according to an aspect of the subject matter described herein;

FIG. 3 is a message flow diagram of an exemplary communication session between a client device, a network server, and a client server for providing a command result according to an embodiment of the subject matter described herein;

FIGS. 4A-4C are a flow chart of another exemplary process for providing command results according to an embodiment of the subject matter described herein;

FIG. 5 is an exemplary screen display for a web browser GUI according to the subject matter described herein;

FIG. 6 is a block diagram of another example of a network for providing search results to a client device according to an aspect of the subject matter described herein;

FIGS. 7A and 7B are a flow chart of another example of a process for providing command results according to an aspect of the subject matter described herein;

FIG. 8 is a block diagram of another example of method and system for providing search results to a client device according to an aspect of the subject matter described herein;

FIG. 9 is a flow chart providing additional examples of possible applications using a network in accordance with the present disclosure, including but not limited to a network such as that illustrated in FIG. 8; and

FIG. 10 is a flow chart of an example of a process for providing location-related data to a client device according to an aspect of the subject matter described herein.

### DETAILED DESCRIPTION

According to one aspect, the subject matter described herein includes methods, systems, and computer program products for providing command results. One method includes receiving a command from a client device. The method can also include retrieving command results based on the command. Further, the method can include communicating to the client device, for example in response to the received command, a document in a displayable format and including a first portion of the command results. The method can also include communicating to the client device supplemental data that can include a second portion of the command results.

According to another aspect, the subject matter described herein includes methods, systems, and computer program products for retrieving command results. One method includes communicating a command to a server. The method can also include receiving from the server and for example in response to the communicated command, a document in a displayable format and including a first command result. Further, the method can include receiving, from the server, a file including a second command result.

According to another aspect, the subject matter described herein includes methods, systems, and computer program products for providing search results to a client device. One method includes receiving user search criteria from a client device. The method can also include retrieving a first search result based on the user search criteria. Further, the method can include determining predictive search criteria based on the user search criteria or based on the first search result. The method can also include retrieving a second search result based on the predictive search criteria. Further, the method can include communicating the first and second search results to the client device.

The subject matter described herein may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be distributed as represented by multiple physical devices and/or computing platforms.

As referred to herein, the term “client device” is intended to be interpreted broadly and can refer to any suitable device operable to communicate electronically with another electronic device. For example, a client device can include or be any electronic device for communicating with another electrical component in any suitable manner, such as over a network or through a direct connection such as a serial connection. Exemplary client devices can include or be a mobile phone, a smartphone, a personal digital assistant (PDA), a computer, and a media player. A media player can include or be any device suitable for displaying images, and/or playing sounds and/or video. A client device may include a processor, memory, an input interface, and/or an output interface.

As referred to herein, the term “client server” is intended to be interpreted broadly and can refer to any suitable electronic device configured to communicate electronically with another electronic device such as a client device. A client server can receive one or more commands from a client device and implement or initiate a process for executing the commands. In one example, a client server an include or be a search engine server configured to receive one or more search queries from a client device and configured to implement or initiate a process for retrieving search results based on the queries and for communicating the search results to the client device. In another example, a client server can be configured to receive one or more commands from a client device for monitoring and/or operating equipment and configured to implement or initiate a process for monitoring and/or operating the equipment and for communicating information related to the implementation or initiation of the process.

As referred to herein, the term “network” is intended to be interpreted broadly and can refer to a grouping of two or more computers, devices, servers, and/or other electronic components suitable to communicate with one another. A network may include one or more wireless and/or wireline networks. In one aspect, for example only and without limitation, a network can include or be a wide area network (WAN), such as the Internet. In another example, a network can include or be a wireless network, such as a cellular network. In yet another example, a network can include or be a LAN, such as an Ethernet-based network.

As referred to herein, a “network server” is intended to be interpreted broadly and can be any suitable device configured for routing communications between a client device and a client server. A network may include one or more network servers or devices that are intermediary communication devices suitable for routing communications between a client server and a client device. Exemplary network servers can for example include a wireless access point (WAP), a mobile phone base station, and a LAN server. Other exemplary network servers can include a LAN server, a WAN server, a wireless communications base station, an automobile computer operable to wirelessly communicate with a client device, a satellite, and/or other suitable communications devices adapted to receive communications data from a client server and forward the communications to the client device and/or store the communications data until requested by the client device.

As referred to herein, the term “command” is intended to be interpreted broadly and can refer to one or more instructions that can be performed by a device including electronic components. In one aspect, for example only and without limitation, a command may include or be a computer-readable instruction that can be processed and implemented by a computer, such as a client device, a client server, and any other suitable network-based device. In another example, a command may include or be one or more instructions for operating and/or monitoring appliances or equipment. In yet another example, a command may include or be one or more search queries for use in conducting a search of a database. For example, a command may include a search query including one or more search phrases, words, terms, and/or filter criteria for use in conducting a search of a network, such as the Internet or the World Wide Web. In another example, a command may include a search query for searching a database of communication-related data such as phone call related data, Instant Message (IM) data, blog related data, e-mail related data, and the like.

As referred to herein, the term “document” is intended to be interpreted broadly and can refer to any suitable document for read and/or display by a device, such as a client device. A document may be in displayable format for view by a client device. A document may include command results. In one example, a document may be an HTML format document viewable by a web browser of a client device and including search result data related to a search query from the client device.

As referred to herein, the term “supplemental data” is intended to be interpreted broadly and can refer to any suitable data resulting from the execution and/or initiation of a command and generated for communication to a client device. The supplemental data can include or be an invisible or visible portion of command results that is not included in a document in a display format. Further, the supplemental data can include or be compressed data and/or encrypted data. In one example, supplemental data can include search result data based on a search query from a client device. Supplemental data can be tagged or include metadata indicating that the data is not for immediate display by a client device. In one example, supplemental data can be tagged or include metadata indicating that the data is to be stored by a network server. In this example, the supplemental data can be stored by the network server until requested by a client device or deleted by the network server. Exemplary supplemental data includes data files, text files, program files, directory files, and web data. Supplemental data can include an executable including instructions for analyzing command results included in the supplemental data, for analyzing search results in the communicated document, and/or for conducting additional searches based on a command received from a client device. Supplemental data can include data resulting from a database search, such as a database containing web data (e.g., web site data from the Internet). In one example, supplemental data can include data results from a metasearch (i.e., a search combining results from more than one search, with each search typically being conducted over a different content collection). Supplemental data can include location-related data.

As referred to herein, the term “predictive search criteria” is intended to be interpreted broadly and can refer to search criteria generated based on search criteria or queries generated by a user and/or search results generated from the user search criteria or queries. Predictive search criteria can be search criteria predicted to follow a search query received from a user. For example, predictive search criteria can be stored in a table and associated in the table with search criteria previously received from users or client devices. In one example, the predictive search criteria or queries can be criteria or queries that are statistically likely to be received based on another search query received from a client device.

As referred to herein, the term “communication session” is intended to be interpreted broadly and can refer to the communication of a message, information, and/or data, such as an online communication, for example between a client device and a client server. The communication session may also include the communication of a command message and/or a response, such as command results, by the client server. The response may be received by the client device or an electronic device associated with client device, such as a network server.

The components described herein (e.g., servers, client devices, device components, databases, interfaces and functions as described herein) can be connected via any suitable technique for communicating information, documents, and any other data described herein. Exemplary communication techniques include wireless communication, wired communication, digital communication, analog communication, direct communication, indirect communication, radio communication, and combination thereof. Another exemplary communication technique includes satellite communication. The components may communicate via any suitable network, such as LAN (using, for example, Ethernet or WiFi) and WAN (using, for example, IP). Networks can include any suitable number of routing components or other suitable components for communicating data between devices. Further, data for communication between devices and/or servers may be distributed within one or more messages (e.g., packets or datagram) for communication to a receiving device. Further, data for communication between devices and/or servers may be inserted into multiple messages for message communication redundancy to assure communication of data to a recipient device. The data described herein may be communicated over networks such as the public switched telephone network (PSTN), the Internet, any suitable IP network, integrated services digital network (ISDN) and any suitable packet switching network. Further, the data described herein may be communicated using any suitable communication protocol such as Internet protocol, a connection-oriented protocol, and a connectionless-oriented protocol. Devices may be connected via a serial connection, a parallel connection, metal wire connection, fiber optic connection, combination thereof and/or any other suitable connection for communication data.

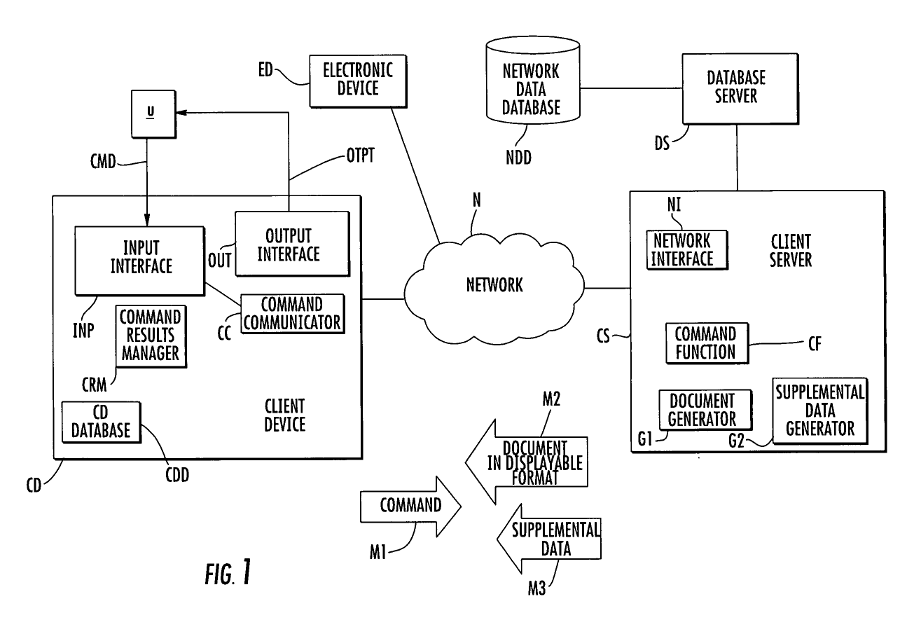

Referring now to the various figures of drawings that provide, without limitation, illustrative examples of aspects of the present subject matter. FIG. 1 is a block diagram of an exemplary network including a client device CD and a client server CS according to the subject matter described herein. Referring to FIG. 1, client server CS can include or be any suitable server configured to receive commands from a client device, such as client device CD, and to implement commands. Client server CS may include a network interface NI suitable for receiving commands over network N and outputting information to network N. For example, client server CS can include or be a search engine server configured to search web data, such as pages of the World Wide Web (web pages), based on search queries received from a client device. In this example, client server CS can retrieve web data based on a search query and communicate the search results to client device CD.

In another example, client server CS can be any suitable server configured to receive commands from client device CD via a network N and configured to communicate information related to the command to client device CD over network N. In this example, client server CS may initiate processes for performing the command. In this example, client server CS can include or be a server located at a house or building and operable to receive commands or instructions from client device CD for operating and/or monitoring appliances and/or equipment at the house or building. Client server CS can implement the commands and provide information related to the commands to the client device. For example, client server CS can provide information associated with operating equipment and/or equipment monitoring information.

Client device CD and client server CS can be configured to communicate via network N. Client device CD and client server CS may be configured to communicate with one another using one or more suitable network protocols. Network N may be any suitable network for communicating data between client device CD and client server CS.

Further, client device CD can be configured to receive a command CMD input by a user U and communicate command CMD to client server CS. User U may be an operator of client device CD or another electronic device configured to interface with client device CD. Client device CD can include or be any suitable network-enabled device for communicating to network components via network N. Client device CD can include an input interface INP and an output interface OUT. Input interface INP can include any suitable interface for receiving user input, such as command CMD, from user U. For example and without limitation, input interface INP can receive input including commands or inquiries, such as a search query, instructions to monitor equipment, instructions to control equipment, or other commands or inquiries. Exemplary input interfaces can include, for example and without limitation, a keyboard, a keypad, a mouse, a touch screen display, voice recognition components, or other suitable input interfaces. Output interface OUT can include, for example and without limitation, any suitable interface for presenting output to user U. For example, output interface OUT can present information to user U that is related to search queries and monitoring/controlling equipment. Exemplary output interfaces can include, for example and without limitation, a display, a printer, a speaker, a projector, or other suitable output interfaces.

Client device CD can include a command communicator CC configured to receive a command, such as command CMD, from input interface INP, format the command for communication to client server CS, and communicate the command to client server CS. For example, command communicator CC can include or be a web browser adapted to receive a command, such as a search query, and to communicate the command to client server CS. In another example, command communicator CC may include or be a suitable application or component configured to receive a user command and/or configured to communicate the command to client server CS.

Client device CD can include a command results manager CRM configured to access and display a command result received from client server CS or another suitable source, such as a network component. A command result can include or be information resulting from the initiation and/or execution of a command by client server CS. For example, command results manager CRM can be used for accessing and viewing web pages. In this example, client server CS can provide information, such as a uniform resource locator (“URL”), for accessing a web page on the Internet. Further, in this example, the web page can be accessed by command results manager CRM over network N and displayed via output interface OUT. User U can enter data into input interface INP for selecting search results for display.

Further, client device CD can be configured to access and present images, sound data or files, video data or files, data files, or other data to user U. For example, client device CD can be operable to recognize an image file and display the image associated with the file to user U. In another example, client device CD can be operable to recognize sound data or file and play the sound file to user U via output interface OUT. For example, output interface OUT may be operable to produce output OTPT (shown as an arrow), such as sound, images, and/or any other output that may be perceptible by user U. In another example, client device CD can be configured to recognize a video file and present a video associated with the file via output interface OUT. In one example, client device CD can be configured to recognize a data file, convert the data file to a user-readable format, such as a text file, a word processing document, or a spreadsheet. Client device CD can decompress a compressed file and display the contents of the file.

Client device CD can be in communication with client server CS via network N. Alternatively, client device CD can be in communication with client server CS via any suitable network, such as the Internet, a wireless and/or wired network, and/or a local area network (LAN) and/or wide area network (WAN). Further, client device CD can be in communication with the network N by a wired or wireless connection. A wired connection can be implemented by any suitable technique such as by using xDSL technology. A wireless connection can be implemented by any suitable technique such as BLUETOOTH® technology, wireless phone technology, and the like. In one example, client device CD may include or be a PDA in wireless communication with a wireless access point.(WAP). In another example, client device CD may include or be a mobile phone or a smartphone in wireless communication with a cellular base station.

Client device CD may be operably connected to a client server CS for communication of a command message M1 including command CMD and receipt of command results included in a command results message CRM. A command can be entered into client device CD via input interface INP. The command can be a search query including text and/or filter criteria. For example, the text of a search query may include or be one or more keywords, phrases, and/or digits. In this example, search engine SE can search for web documents and/or data related to the data in the search query. The search query may also include filter criteria that can include instructions for narrowing search results. For example, filter criteria can designate types of documents and/or files to which the search results should be limited. Exemplary filter criteria can include language, modification date, location of search criteria text, web domain, usage rights, categorization, or other filter criteria. Command message CM may be communicated to client server CS via network N.

Client server CS may be operable to receive command message CM communicated over network N from client device CD. Client server CS can execute instructions based on the command received. For example, if the command is a search query, client server CS can initiate a search of the contents of a network data database NDD to locate network documents, data, and/or files based on the command. In this example, client server CS can communicate a request to database server DS to conduct a search of database NDD. Database server DS can conduct a search of the contents of database NDD for network documents, data, and/or files that contain the one of more keywords contained in the search query. Further, a search query can be communicated to a database in addition to database NDD for retrieving search results. Further, the located network documents, data, and/or files can be filtered based on filter criteria provided in the command. Network documents, data, and/or files that do not meet the filter criteria can be excluded from the search results.

Database NDD can include network documents and files. The documents can include web documents, word processing documents, presentation documents, spreadsheets, or other documents. The files can include image files, sound data or files, video data or files, data files, or other files. Search engine SE can also include data associated with documents and/or files. For example, the data associated with documents and/or files may be a portion of a document or file. In this example, the data can be associated with a document and/or file contained in database NDD or retrieved by a network search or otherwise received by database NDD.

The contents of database NDD can include documents and/or files accessible over a network, such as the Internet. For example, the contents of database NDD may include copies of network documents, data, and/or files retrieved by spidering the Internet. A document contained in database NDD may be a web document that is identified on the Internet by an URL. In one example, in response to receiving a command from client device CD, client server CS can retrieve documents and/or files via the Internet.

Client server CS can include a command function CF configured to generate command results based on a command received from client device CD. For example, command function CF can receive a search query from client device CD and generate search results based on the search query. A search result can include one or more documents located based on the command, one or more files located based on the command, portions of one or more documents located based on the command, portions of one or more files located based on the command, and/or any other data contained in database NDD. Further, for example, the command results may include portions or the entireties of one or more network documents, data, and/or files located based on a search of a network using search criteria of a command. For example, the command results may include a search of a network, such as the Internet.

The command results generated by client server CS can be organized into one or more portions for communication to client device CD. Client server CS can include a document generator GI operable to generate a document in a displayable format that includes a portion of the command results. For example, a web document for view by client device CD can be generated that includes a portion of the command results. In one example, the command results can be a portion of web documents retrieved by a search of the Internet based on a search query received from client device CD. In another example, the command results can be a portion of information associated with operating equipment and/or equipment monitoring information based on commands or instructions from client device CD for controlling and/or monitoring the equipment.

A data generator G2 can generate supplemental data including a portion of the command results that is not included in the document in a displayable format. The supplemental data can be invisible or hidden such that a user may not be aware of its presence accompanying other data, or the supplemental data can be visible data such that a user is aware of its presence. Data generator G2 can organize the supplemental data in any suitable file format for communication to client device CD via network N. Exemplary supplemental data can include, for example and without limitation, data files, text files, program files, and directory files. Further, supplemental data can include command results tagged to indicate that this portion of the command results is not for immediate display. The supplemental data can be compressed command results for facilitating communication to client device CD.

Supplemental data can include data associated with a web document identified in the document in displayable format. For example, the supplemental data can include or be a web document identified by a link or an URL text in the document in displayable format. In another example, the supplemental data can include a plurality of web documents linked to a web document identified by a link or an URL text in the document in displayable format.

Supplemental data can include data associated with operating equipment and/or equipment monitoring information based on commands or instructions from client device CD for controlling and/or monitoring the equipment. For example, the data associated with operating equipment and/or equipment monitoring information can include additional control and/or monitoring information at a house or building.

In one embodiment, command results can be organized into different portions based on a relevancy of the command results to a command received from client device CD. For example, in the case of a search query to client server CS, search results can be ranked and organized into different portions based on a relevancy ranking of the search results with respect to search criteria. In this example, higher ranked search results can be included in a document in a displayable format. Further, in this example, lower ranked search results can be included in the supplemental data.

The portion of command results included in a document in a displayable format can be formatted, organized, and portioned in an amount suitable for display or presentation by client device CD. For example, client server CS can determine that client device CD is a PDA. In this example, the document can be formatted for fitting a display screen of client device CD. Further, in this example, the portion amount of command results included in the document can be set to a predetermined portion amount for fitting the display screen. In another example, client server CS can determine that client device CD is a desktop computer having a 20″ display. In this example, the document can be formatted for fitting the 20″ display. Further, in this example, the portion amount of search results included in the document can be set to a predetermined portion amount for fitting the 20″ display. In one example, client device CD can be configured to communicate data to client server CS for indicating a display type of client device CD.

Client server CS can communicate a document message M2 comprising the document in displayable format that can include a portion of the command result to client device CD via network N. Further, client server CS can communicate a supplemental data message M3 comprising supplemental data including other portions of the command results to client device CD via network N. The document in displayable format and the supplemental data can be communicated to client device CD in the same on-line connection as the supplemental data or in a different on-line connection than the supplemental data. Further, the document and the supplemental data can be communicated to client device CD in the same transmission.

In one embodiment, client server CS can communicate the document in displayable format and the supplemental data to a network server associated with client device CD. The network server can be operable to communicate the document in displayable format and the supplemental data to client server CS. In one example, the network server associated with client device CD can be a network server adapted to serve client device CD in a LAN. In this example, the network server can communicate the document in displayable format to client device CD in response to receiving the document. Further, the network server can store the supplemental data until receiving a request from client device CD to receive the data. The supplemental data can be temporarily stored by the network server. The supplemental data can be stored by the network server until receiving a command from client device CD for requesting a portion or the entirety of the supplemental data or until the expiration of a predetermined time period. Storing supplemental data at the network server can be beneficial, for example, because communication bandwidth between the network server and client device CD is not utilized unless the supplemental data is requested by client device CD. Further, for example, the supplemental data stored at the network server can be readily available to client device CD upon request without communicating the request to client server CS. As a result, the supplemental data may be provided to client device CD more efficiently and quickly.

Supplemental data can include an executable including instructions for analyzing the command results included in the supplemental data, for analyzing the search results in the communicated document, and/or for conducting additional searches based on the command from client device CD. For example, an executable can be communicated that includes instructions for filtering the command result included in the supplemental data. In another example, an executable can be communicated that includes instructions for displaying the command result included in the supplemental data. In another example, an executable can be communicated that includes instructions for searching the command result included in the data and/or for searching data on network N or other networks.

Client device CD can be operable to receive the document in displayable format and the supplemental via network N. Client device CD may display the document via output interface OUT. For example, the document can be in HTML format and displayed via output interface OUT. Client device CD can be operable to organize the command results contained in the supplemental data into a displayable document for display via output interface OUT. For example, the command result in the supplemental can be organized in a relational format, and client device CD can be operable to organize the file contents into a document for display via output interface OUT. Further, client device CD can be operable to decompress compressed data contained in the supplemental data.

Client device CD can be configured to run executable instructions provided by client server CS for analyzing the command result included in the communicated file, for analyzing the command result in the communicated document, and/or for conducting additional commands based on the command submitted by client device CD. For example, client device CD can be operable to execute instructions for filtering the command result, such as search results, included in the supplemental data. In another example, client device CD can be operable to execute instructions for displaying the command result included in the supplemental data. In another example, client device CD can be operable to execute instructions for searching the command result included in the supplemental data. For example, client device CD can be operable to execute instructions for searching network N for additional search results.

In one embodiment of the subject matter described herein, a user can input a command into a client device to search for media content or to select media content. Exemplary media content can include video files, sound files, and/or other suitable media content. An example of a video file can be a movie, television show, and/or any associated data. An example of a sound file can be music and/or any associated data. An example command can include a word, a phrase, and/or digits for use in searching for media content. Exemplary input into a client device for selecting media content can be selection of an identifier for media content or entry of a name identifying media content. The input command can be suitably formatted and communicated to a client server for searching for the media content. In one example, the client server can identify media content (e.g., a movie, music, television show, and/or another other associated data) based on the command and communicate the media content to an electronic device via the Internet or another suitable network. The electronic device can be any suitable device identified for receiving the media content. For example, the electronic device can be a computer identified by the client device. In one example, the user can have an account with the client server and the account can be associated with identification information for sending the media content. Further, in this example, the user can provide information to the client server for identifying the electronic device. Further, the client server can communicate a listing of media content to the client device based on the command, such as in a document in displayable format. The user can input data for selecting one or more of the media content. The selection can be communicated to the client server. In response, the client server can communicate the selected media content to the identified electronic device as supplemental data. Further, in response, the client server can communicate a document in displayable format that provides information associated with communication of the media content, such as information indicating that the communication was successful. This feature may be advantageous, for example, when a user desires to select media content with a client device (e.g., a PDA) and communicate the media content to another electronic device (e.g., the user's home computer.

In one embodiment, the network shown in FIG. 1 can be used by a client device for searching for media content or for selecting media content. For example, user U can input command CMD into client device CD that includes information for identifying or searching for media content. Client device CD can communicate a message including the information to client server CS. Client server CS can search for media content based on the information and/or obtain media content identified by the information. A listing of the media content can be placed in a document in displayable format, which can be communicated to client device CD. User U can select one or more of the media content listed in the document and communicate the selection to client server CS using client device CD. For example, the document can be an HTML document or any other suitable document including links corresponding to the media content. In this example, on selection of a link associated with media content, client server CS can be notified and, in response, send the media content to an identified electronic device ED. Alternatively, in one example, a user can enter a command indicating the identified media content, the command can be sent to client server CS, and client server CS can communicate the identified media content to electronic device ED. In response to media content being identified by the message including input command CMD information or the selection, the identified media content can be obtained by client server CS and communicated as supplemental data to an electronic device ED via network N. Further, information associated with communication of the media content to electronic device ED can be placed in a document in displayable format and communicated to client device CD. This feature may allow, for example, a user of client device CD to select or search for one or more movies, music, or other suitable media content by using client device CD and communicate the media content to electronic device ED. For example, a user can utilize the client device CD at a location remote from electronic device ED and send the media content to electronic device ED, such as a digital video recorder (DVR). Media content, such as movies, can require a long time for download. It may be beneficial for a user to request the download while in transit to the electronic device so that download can commence and be ready when the user arrives at the electronic device.

In one aspect, commands can be entered or input by a “one-click” process. For example, any button on a client device can be depressed to provide input for communicating a command as described herein to a client server. In one example, a display of a client device can display one or more icons, menus, or other suitable indicia that can be selected by a user for communicating a command as described herein to a client server. Further, in one example, one or more commands can be initiated by selecting one or more icons displayed in a sequence of display screens or menus for providing a guide to a user for initiating the one or more commands. One or more commands can be stored in the client device and initiated by the user using the “one-click” process. This feature may be advantageous, for example, because a user will not be required to enter text into a client device for initiating a command for communication to a client server. This feature may be particularly advantageous for use in personal electronic apparatuses such as for example personal digital assistants (PDAs) or smartphones.

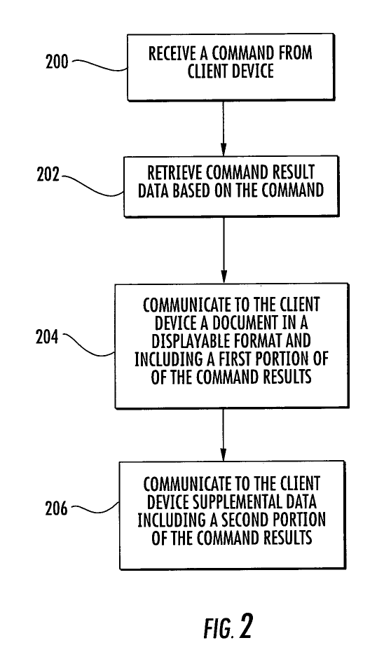

FIG. 2 is a flow chart illustrating one example of a process for providing command results according to an aspect of the subject matter described herein. Referring to FIG. 2, in block 200 a command can be received from a client device. In block 202, command results can be retrieved based on the command. Next, in block 204, a document in a displayable format and including a first portion of the command results can be communicated to the client device. Supplemental data including a second portion of the command results can be communicated to the client device (block 206).

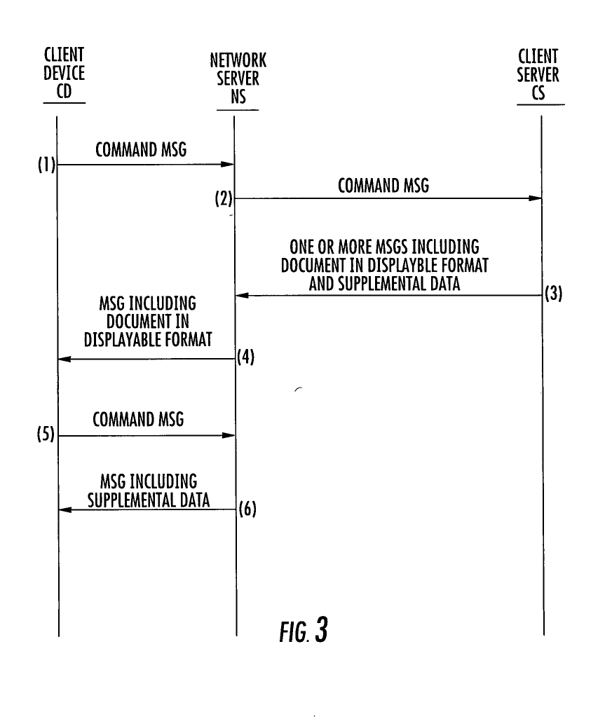

FIG. 3 is a message flow diagram of an exemplary communication session between client device CD, a network server NS, and client server CS for providing a command result according to an embodiment of the subject matter described herein. Initially, a user can enter a command into client device CD. Client device CD can generate a command message including the command for communication to client server CS. In step 1, client device CD can communicate the command message to network server NS for forwarding to client server CS.

In response to receiving the command message, network server NS can generate a record of the command message for client device CD. For example, client device CD can be a subscriber and the record can be used for tracking results of the command message, such as responses and data received from client server CS based on the command message. In another example, the record can be used for tracking results of a search query from client device CD to client server CS. The record can be associated with client server CS by an identifier such as a phone number, IP address, or another suitable client device identifier.

In step 2, network server NS can forward or route the command message to client server CS. For example, the command message can be routed to client server CS over the Internet. In another example, the command message can be routed to client server CS via a LAN. In another example, the command message can be routed to client server CS via a wireless or wired network.

In response to receiving the command message, client server CS may implement the command and retrieve command result. The command result can be retrieved from a database accessible by client server CS. For example, the command result can be retrieved from database server DS. Client server CS can generate a document in displayable format that can include a portion of the command result. Further, client server CS can generate supplemental data that can include another portion of the command result and/or an executable associated with the command. Next, client server CS can generate one or more messages that can include a portion or the entireties of the document in displayable format and the supplemental data. In step 3, client server CS can communicate the one or more messages including the document in displayable format and the supplemental data to network server NS. The one or more messages can be communicated to network server NS in any order. Further, the messages can be communicated to network server NS at the same time or during subsequent message communications between any of client device CD, network server NS, and client server CS. Communication of the messages containing the document and the supplemental data can be tracked for organization by network server NS and associated with client device CD and/or client server CS. This feature may be advantageous, for example, for proceeding with communicating of a portion of command result in the document in displayable format to client device CD while client server CS is retrieving additional command results.

Network server NS can receive the one or more messages and enter tracking information into a record for client device CD for tracking communication of the messages. Further, network server NS can store the messages. In step 4, network server NS can communicate all or some of the one or more messages to client device CD. For example, network server NS can communicate one or more messages including the document in displayable format to client device CD. In this example, network server NS can communicate one or more messages including the supplemental data to client device CD. Further, in this example, network server NS can store some or all of the supplemental data until requested by client device CD or until the expiration of a predetermined time period.

Client device CD can receive the one or more messages. Further, client device CD can display the document in displayable format contained in the one or more messages. Further, client device CD can store some or all of the supplemental data contained in the one or more messages. Client device CD can also execute any executables contained in the supplemental data.

A user of client device CD can enter another command into client device CD. The command can be directed to client server CS for retrieving additional command result. Client device CD can generate a command message including the command. In step 5, client device CD can communicate the command message to network server NS. As described above, network server NS can track communications for client device CD. The command message can be associated with a record for client device CD and supplemental data being stored for client device CD. Based on the command in the command message, network server NS can generate a message containing all or some of the supplemental data stored at network server NS. In one example, the supplemental data can be data retrieved using a search query in the command message received from client device CD. In this example, the supplemental data can include search results that were not included in the document in displayable format, such as web documents that were not as highly ranked as the web documents identified in the document in displayable format.

In step 6, network server NS can communicate the message including the supplemental data to client device CD. Client device CD can store the supplemental data, execute an executable contained in the supplemental data, and/or display or otherwise present the supplemental data.

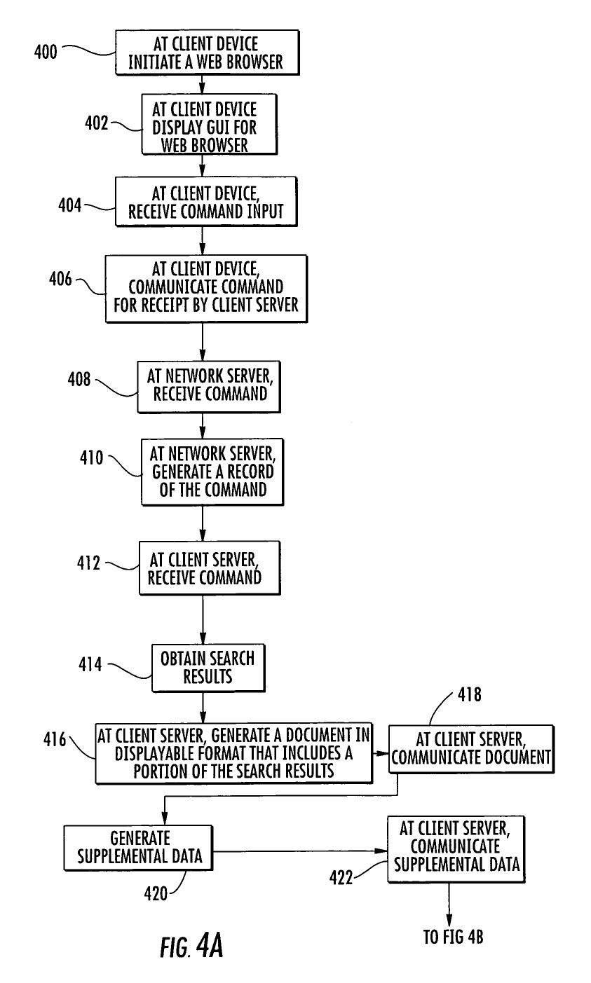

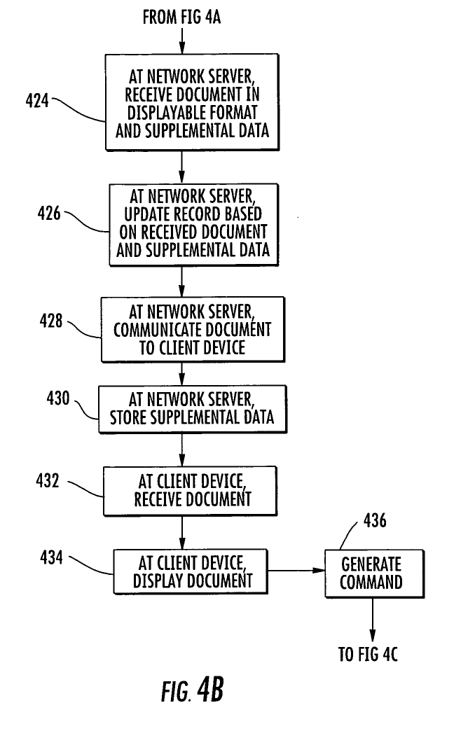

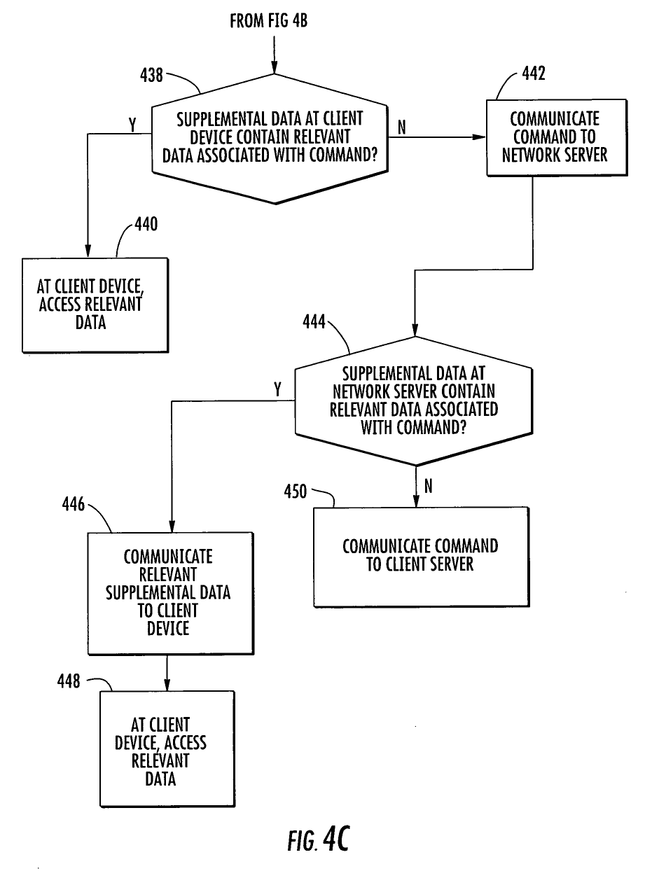

FIGS. 4A-4C provide a flow chart illustrating another exemplary process for providing command results according to an embodiment of the subject matter described herein. In this example, reference is made to the components shown in FIGS. 1 and 3. Further, in this example, network server NS shown in FIG. 1 can be a component of network N shown in FIG. 1. In block 400 of FIG. 4A, user U can enter input into input interface INP for initiating a web browser. The web browser can be initiated and display a GUI on output interface OUT for user interaction (block 402).

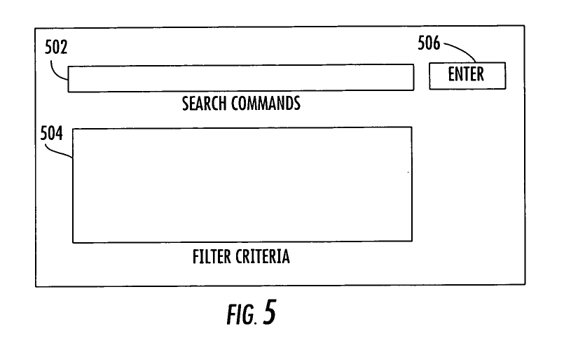

FIG. 5 illustrates an exemplary screen display for a web browser GUI according to the subject matter described herein. The screen display can be displayed by output interface OUT of client device CD. For example, client device CD can include a display for displaying the screen display. Referring to FIG. 5, the screen display can include a command text box 502 for receiving a command. For example, user U can use input interface INP for selecting text box 502 for entering search criteria. Further, the screen display can include a filter criteria text box 504 for receiving filter criteria. For example, user U can use input interface INP for selecting text box 504 for entering filter criteria. In one example, the search criteria and filter criteria can be command instructions for searching stored web documents. A command entry box 506 can be selected for submitting the entered command to the web browser.

Referring again to FIG. 4A, the GUI of client device CD can receive command input for communication to client server CS (block 404). For example, the command input can be search terms for use in searching web documents accessible by client server CS. The command input can be received via a GUI having a screen display such as the screen display shown in FIG. 5.

In block 406, client device CD can communicate the command for receipt by client server CS. For example, client device CD can format the command for communication via a network interface component over a network as known to those of skill in the art. The web browser content can be provided by client server CS operating as a search engine. On entering the command, the web browser can initiate communication of the command to client server CS.

The command can be communicated to network server NS for routing to client server CS (block 408). Further, network server NS can generate a record of the command for client device CD (block 410). Network server NS can route the command to client server CS via network N.

In block 412, client server CS can receive the command. In response to receiving the command message, client server CS may implement the command and retrieve command result (block 414). The command result can be retrieved from a database accessible by client server CS. The results can be web documents that are relevant to a search query in the command. For example, the results can be a plurality of relevant web pages and/or web page content, such as images, video, and sound data. Command result can be retrieved using suitable search techniques, such as suitable search engine techniques for searching web documents based on a search query.

In block 416, client server CS can generate a document in displayable format that includes a portion of the command result. In block 418, client server CS can communicate the document for receipt by client device CD.

In block 420, client server CS can generate supplemental data including another portion of the command result and/or an executable associated with the command. In block 422, client server CS can communicate the supplemental data for receipt by network server NS.

Referring to FIG. 4B, in block 424 the document in displayable format and the supplemental data can be received by network server NS. The record maintained for the command from client device CD can be updated based on the received document and supplemental data (block 426). For example, the record can be updated to indicate that the document was forwarded to client device CD and that network server NS is being stored by network server NS. In block 428, network server NS can communicate the document to client device CD. In block 430, network server NS can store the entirety or a portion of the supplemental data. Further, another portion of the supplemental data can be communicated to client device CD.

In block 432, client device CD can receive the document in displayable format. Further, in block 434, client device CD can display the document in displayable format. The displayed document can show all or a portion of command result. For example, the displayed document can show all or a portion of web documents. If supplemental data is communicated, client device CD can receive commands for accessing the supplemental data as described herein.

In block 436, a command can be generated at client device CD that is associated with the command input at block 404 and/or the associated command result. For example, the command at block 436 can be a search query associated with a search query input at block 404. In this example, the search query can be a query expanding or narrowing the search query input at block 404.

Further, the command at block 436 can be any command associated with the supplemental data. In this example, the search query can be a command for executing an executable stored as supplemental data.

The command at block 436 can be a request for data associated with a web document identified in the document in displayable format. For example, the command can be a request to display a web document identified by a link or URL text in the document in displayable format. In another example, the command can be a request to display any of a number of web documents linked to a web document identified by a link or URL text in the document in displayable format.

Referring to FIG. 4C, in block 438 client device CD can determine whether supplemental data at client device CD includes data associated with the command. Client device CD can include supplemental data that was previously received from network server NS and/or client server CS. Client device CD can determine whether the previously received supplemental data includes data associated with the command at block 436. In one example, client device CD can determine whether the supplemental data stored at client device CD include relevant search results to a command at block 436 including a search query. In another example, the command can be a request for an executable, and the determination can be whether the supplemental data includes the executable. This feature can be advantageous, for example, because a command will not need to be communicated to network server NS and/or client server CS if relevant data is contained in the supplemental data. As a result, client device CD will not need to establish another communication session.

If it is determined that the supplemental data at client device CD includes data associated with the command, the relevant data in the supplemental data at client device CD can be accessed (block 440). The data can be accessed for display, execution, and/or analysis. For example, if the supplemental data includes relevant search results, the search results can be displayed via output interface OUT of client device CD. In another example, if the command is a request for an executable, the executable can be executed.

If it is determined that the supplemental data at client device CD does not include data associated with the command, client device CD can communicate the command to network server NS (block 442). In response to receiving the command, network server NS can determine whether its supplemental data stored for client device CD includes relevant data associated with the command (block 444). If network server NS includes relevant supplemental data, network server NS can communicate the relevant supplemental data to client device CD (block 446). Client device CD can receive the relevant supplemental data from network server NS and access the supplemental data (block 448). The feature of storing supplemental data at a network server can be advantageous, for example, because a command will not need to be communicated to client server CS if relevant data is contained in the supplemental data at the network server. As a result, a communication session will not have to be established with client server CS based on the command.

If network server NS does not include relevant supplemental data, network server NS can communicate the command to client server CS (block 450). In one example, network server NS may not store supplemental data for client device CD. In this example, network server NS does not check supplemental data. Rather, network server NS can route the command to client server CS. In another example, network server NS can include a record for client device CD for use in determining whether supplemental data is stored for client device CD. If the record indicates that the supplemental data is not stored for client device CD, the command can be routed to client server CS. For example, the command can be a search query for a search engine.

In one embodiment, command results can include predictive command results based on a command received from a client device. In one example, client server CS can receive a search query from client device CD. Client server CS can retrieve one or more search results based on the search query. Further, client server CS can determine one or more predictive search queries based on the search query received from client device CD and/or based on the one or more search results. The predictive search queries can be search queries that are predicted to follow the command received from client device CD. In one example, the predictive search queries can be determined based on previously received search queries from client devices. The predictive search queries can be queries that are statistically likely to be received based on another search query received from a client device. Client server CS can use the one or more predictive search queries for retrieving another set of search results, or command results. Client server CS can communicate the search results to client device CD. The search results can include the search results retrieved based on the search query received from client device CD and the search results retrieved based on the predictive search queries. Further, client server CS can communicate the predictive search queries to client device CD.

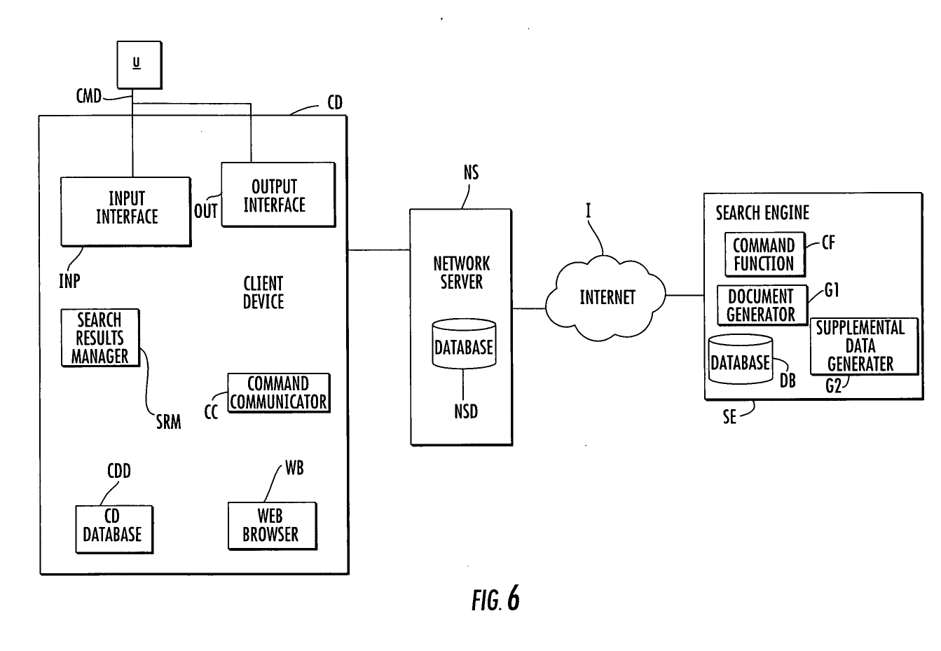

FIG. 6 is a block diagram of another example of a network for providing search results to a client device according to an aspect of the subject matter described herein. Referring to FIG. 6, user U can utilize client device CD for entering a search query for retrieving search results. The search query can be communicated to a search engine SE via the Internet I. Client device CD can include an input interface INP and an output interface OUT. Input interface INP can include any suitable interface for receiving user input from user U. Output interface OUT can include any suitable interface for presenting output to user U.

Client device CD can include a web browser WB for accessing and displaying network data. For example, web browser WB can be used for accessing and viewing web pages. Web pages can be accessible by web browser WB over the Internet I and displayed via output interface OUT. User U can enter data into input interface INP for selecting web pages for display.

A search query may be entered into client device CD via input interface INP. The search query may include text and/or filter criteria. For example, the text of a search query may include one or more keywords. The search query may include filter criteria. The search query may be communicated to search engine SE via the Internet I.

Search engine SE may receive the search query communicated from client device CD. Search engine SE may include a database DB containing web documents and/or files. The documents may include web documents, word processing documents, presentation documents, spreadsheets, or other documents. The files may include sound files, image files, video files, data files, or other files. Search engine SE can also include data associated with documents and/or files. For example, the data associated with documents and/or files can be a portion of a document or file. In this example, the data can be associated with a document and/or file contained in database DB or retrieved by a network search or otherwise received by database DB.

Search engine SE can conduct a search of the contents of database DB to locate document and/or files based on the search query. For example, the contents of database DB can be searched for documents and/or files that contain the one of more keywords contained in the search query. Further, for example, the located documents and/or files may be filtered based on the provided filter criteria.

Further, search engine SE can determine a predictive search query based on the user search query or based on the search results. A predictive search query may be a search query that is determined likely to be requested by a user that enters the user search query. For example, search engine SE may maintain a table including an entry matching the user search query. The entry may also include one or more predictive search queries. A matching entry may be a partial or entire match of words or other information contained in the user search query. In one example, search engine SE may determine the predictive search query based on a statistical analysis of previously entered user search queries from one or more other users. In this example, search engine SE may determine that two or more search queries are commonly separately entered in the same search session with a user. Thus, it may be assumed that a user entering one of the search queries will likely enter the other search query in the same search session. The unentered search query may be considered a predictive search query.

In another example, search engine SE may determine the predictive search query based on a categorization of search queries. If an entered user search query is grouped in the same category as another search query, the other search query may be considered a predictive search query. For example, a user search query of “luxury cars Lexus” may be associated with a predictive search query of “luxury cars Mercedes Benz”. Further, for example, a user search query of “Blackberry PDA” may be associated with a predictive search query of “Palm Treo PDA”.

Search engine SE can conduct a second search of the contents of database DB to retrieve documents and/or files based on the predictive search query. For example, the contents of database DB can be searched for documents and/or files that contain the one of more keywords contained in the predictive search query. Further, for example, the located documents and/or files may be filtered based on the provided filter criteria.

Search engine SE may communicate all or a portion of the search results based on the user search query and the predictive search query to client device CD. All or a portion of the search results based on the user search query can be communicated to client device CD in a document in a displayable format. All or a portion of the search results based on the predictive search query can be communicated to client device CD in a file. The search results in the document in displayable format may be displayed on client device CD.

The search results based on the predictive search query can be displayed to the user in response to the user entering other search queries. The search results can be searched based on the other search query. In one example, search engine SE can communicate an executable for use by client device CD in searching the search results.

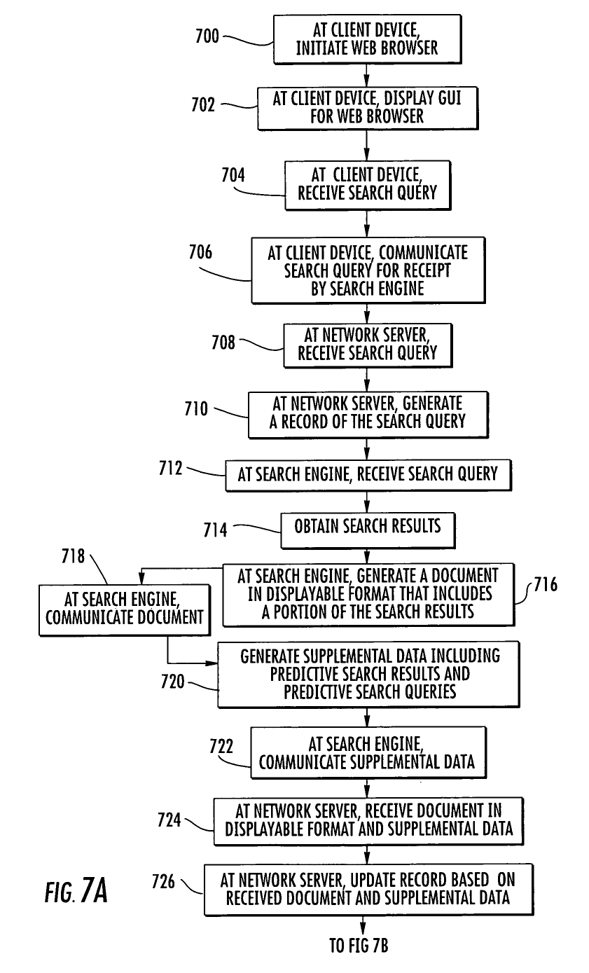

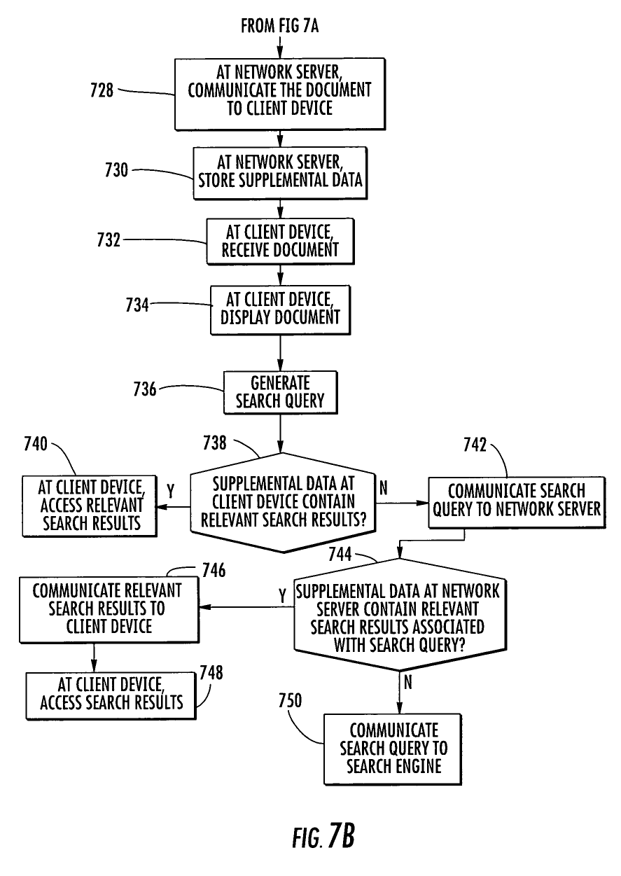

FIGS. 7A and 7B are a flow chart illustrating another example of a process for providing command results according to an aspect of the subject matter described herein. In this example, reference is made to the components shown in FIG. 6. In block 700 of FIG. 7A, user U can enter input into input interface INP for initiating web browser WB. Web browser WB can be initiated and display a GUI on output interface OUT for user interaction (block 702). The GUI of client device CD can receive command input for communication to client server CS (block 704). For example, the command input can be a search query including search terms for use in searching web documents accessible by client server CS.

In block 706, client device CD can communicate the search query for receipt by search engine SE. For example, client device CD can format the search query for communication via a network interface component over Internet I as known to those of skill in the art. The content of web browser WB can be provided by search engine SE. On entering the command, web browser WB can initiate communication of the command to search engine SE as known to those of skill in the art.

The search query can be communicated to network server NS for routing to search engine SE (block 708). Further, network server NS can generate a record of the command for client device CD (block 710). Network server NS can route the command to search engine SE via Internet I.

In block 712, search engine SE can receive the search query. In response to receiving the search query, search engine SE can implement a search based on the search query and retrieve search results (block 714). The search results can be retrieved from a database accessible by search engine SE. For example, the search results can be a plurality of relevant web pages and/or web page content, such as images, video, and sound data. Search results can be retrieved using suitable search techniques, such as suitable search engine techniques for searching web documents based on a search query.

In block 716, search engine SE can generate a document in displayable format that includes a portion of the search results. In block 718, search engine SE can communicate the document for receipt by client device CD.

In block 720, search engine SE can generate supplemental data including another portion of the search results and/or an executable associated with the search results. The supplemental data can also include predictive search queries and predictive search results. In block 722, search engine SE can communicate the supplemental data for receipt by network server NS.

In block 724, the document in displayable format and the supplemental data can be received by network server NS. The record maintained for the command from client device CD can be updated based on the received document and supplemental data (block 726). For example, the record can be updated to indicate that the document was forwarded to client device CD and that network server NS is being stored by network server NS. Referring to FIG. 7B, in block 728 network server NS can communicate the document to client device CD. In block 430, network server NS can store the entirety or a portion of the supplemental data. For example, network server NS can include the entirety or a portion of the predictive search results and the predictive search queries. Further, another portion of the supplemental data can be communicated to client device CD.

In block 732, client device CD can receive the document in displayable format. Further, in block 734, client device CD can display the document in displayable format. The displayed document can show all or a portion of the search results. For example, the displayed document can show all or a portion of web documents. If supplemental data is communicated, client device CD can receive search queries for accessing the supplemental data as described herein.

In block 736, a search query can be generated at client device CD that is associated with the search query input at block 704 and/or the associated command result. For example, the search query in block 736 can include or be a query expanding or narrowing the search query input at block 704.

Further, the search query at block 736 can include or be any search query associated with the supplemental data. In this example, the search query can include or be a command for executing an executable stored as supplemental data.

In block 738, client device CD can determine whether supplemental data at client device CD includes data associated with the command. Client device CD can include supplemental data that was previously received from network server NS and/or search engine SE. Client device CD can determine whether the previously received supplemental data includes data associated with the search query at block 736. In one example, client device CD can determine whether the supplemental data stored at client device CD include relevant search results to a command at block 736 including a search query. This feature can be advantageous, for example, because a search query will not need to be communicated to network server NS and/or search engine SE if relevant search results are contained in the supplemental data. As a result, client device CD will not need to establish another communication session.

If it is determined that the supplemental data at client device CD includes search results associated with the search query, the relevant search results in the supplemental data at client device CD can be accessed (block 740). The relevant search results can be accessed for display, execution, and/or analysis. For example, the search results or a portion of the search results can be displayed via output interface OUT of client device CD.

If it is determined that the supplemental data at client device CD does not include search results relevant to the search query at block 736, client device CD can communicate the search query to network server NS (block 742). In response to receiving the command, network server NS can determine whether the supplemental data stored for client device CD includes relevant data associated with the command (block 744). If network server NS includes supplemental data having relevant search results, network server NS can communicate the relevant search results to client device CD (block 746). Client device CD can receive the relevant search results from network server NS and access the search results (block 748). The feature of storing supplemental data at a network server can be advantageous, for example, because a search query will not need to be communicated to search engine SE if relevant search results are contained in the supplemental data at network server NS. As a result, a communication session will not have to be established with search engine SE based on the search query.

If network server NS does not include relevant search results, network server NS can communicate the command to search engine SE (block 750). In one example, network server NS may not store supplemental data for client device CD. In this example, network server NS does not check supplemental data. Rather, network server NS can route the search query to search engine SE. In another example, network server NS can include a record for client device CD for use in determining whether supplemental data is stored for client device CD. If the record indicates that the supplemental data is not stored for client device CD, the search query can be routed to search engine SE.

In one embodiment, network server NS can be configured to store supplemental data and communicate the supplemental data at predetermined time periods. Network server NS can be configured to communicate supplemental data received for client device CD at a predetermined time period. For example, network server NS may be configured to communicate the supplemental data during a time period when communication rates are reduced, such as a night. In one example, client device CD can communicate information to network server NS that indicates a predetermined time period for communicating supplemental data. This feature may be advantageous for a user because the supplemental data can be communicated at a reduced rate.

In one embodiment, network server NS can be configured to store supplemental data and communicate the supplemental data to another predetermined client device. Network server NS can be configured to communicate supplemental data received for client device CD to another client device, such as a user's home or office computer. In one example, client device CD can communicate information to network server NS that indicates that supplemental data is to be communicated to another identified device. In one example, when the supplemental data is received at network server NS, network server NS may communicate a message to client device indicating that the supplemental data is being stored at network server NS. In this example, client device CD can provide a user with an option of requesting that all or a portion of the supplemental data be sent to client device CD or identifying another client device for receipt of the supplemental data. Communication to the other client device can be performed by the identification of an e-mail address, a phone number, an IP address, or another suitable identifier for a network-based device. Further, in this example, network server NS can receive the information identifying the client device for receipt of all or a portion of the supplemental data, and, in response to receipt of the information, communicate all or a portion of the supplemental data to the identified client device. This feature may be advantageous because a user may desire for the supplemental data to be communicated to another device. Further, this feature may be advantageous when the client device does not have sufficient memory for storing the supplemental data.

In one embodiment, supplemental data can include search tools for use in searching a web site and/or a network. A user can enter into client device CD information identifying a web site and/or network for search. Further, a user can enter a search query. Client server CS can receive the web site and/or network identifier and/or the search query. Based on the received data, client server CS can generate tools for searching the web site and/or network. In one example, client server CS can conduct one or more test searches and/or analysis of the identified web site and/or network for generating search tools. Client server CS may communicate supplemental data including the search tools to client device CD. The search tools may be utilized for searching the identified network and/or web site. Further, the search tools may include a GUI application for use in the searching the network and/or web site. For example, the GUI application may be configured to generate an HTML document for use in searching the network and/or web site. Further, the search tools can include filter criteria for filtering data in the network and/or web site. Exemplary web sites for search can include a news web site, a scientific journal web site, and a commercial web site, such as a book seller web site, a music seller web site, and an auction web site. This feature may be advantageous because it can be used to supplement search tools of a web site.

In one embodiment, supplemental data can be stored at network server NS and network server NS can provide client server CS with information indicating how the supplemental data is organized and/or stored. The information can be provided in a document (such as an HTML document) for presentation by an output interface of client device CD. A user can interact with the presented document for selecting all or a portion of the supplemental data for receipt by client device CD. Network server NS and/or client server CS can organize or categorize the supplemental data and generate identifiers for identifying the organized or categorized supplemental data. This feature can be advantageous, for example, because a user at a client device may be provided with information on how the supplemental data is organized and with an option of only a portion of the supplemental data.

In one embodiment, a client device can store received supplemental data to a peripheral device of the client device that includes a memory. For example, received supplemental data can be automatically stored to a memory key. In another example, the received supplemental data can be received at a computer and automatically communicated to a PDA or other suitable portable computing device in communication with the computer. The supplemental data can be automatically communicated for storage on the peripheral device when it has been received. A user can configure the computer to automatically download the supplemental data to a predetermined device. This feature can be advantageous, for example, when a user desires to quickly download web information and store the information on a peripheral device for use later at a different location.

In one embodiment, client device CD can communicate a search query to client server CS for web-related data, and, in response to receiving the communication, client server CS can generate a list of web pages relevant to the query and supplemental data including the listed web pages and other web pages and/or other data associated with the listed web pages. The other web pages and/or other data can be web pages and/or other data linked to the listed web pages. A web page can include links to several pages. Further, the web page and/or client server CS can maintain information regarding which pages linked to a relevant web page are popular among web users (e.g., linked web pages that are associated with hits above a predetermined number or links that are highest among the web pages linked to a relevant web page). Client server CS can generate supplemental data including the popular web pages and/or data linked to the relevant data. The supplemental data can include the popular web pages and/or data can be communicated to client device CD or network server NS. This feature can be advantageous, for example, because when a user accesses a relevant web page at client device CD, popular web pages and/or data linked to the relevant web page can be quickly accessed without requesting the linked web pages and/or data over a network, such as the Internet. Further, the supplemental data can be deleted after a predetermined time period, deleted after a predetermined number of user inputs (e.g., selecting other web pages a predetermined number of times), and/or deleted after a user closes a web browser of client device CD.

In one embodiment, data can be identified according to priorities and organized in a document in displayable format and in supplemental data for communication according to the priorities. In one example, a document, such as a web document, can include two or more portions that are assigned priorities. In this example, portions with the highest priority can be organized in a document in displayable format and communicated to a client device or to a network server associated with the client device. The lowest priority portions can be organized into supplemental data and communicated to the client device or to the network server associated with the client device. The document portions can be the different portions of a document displayed when the document is displayed on a display device. In one example, text data (such as the text of an article) can have a higher priority than image data (such as a banner at the top of the document). In another example, any suitable type of data can be organized according to priorities and organized in a document in displayable format and in supplemental data for communication according to the priorities. The portions can be associated with priorities when the data is created, such as when a web document is created by a web page designer. Further, a client server can determine priorities of portions of data based on the content or type of the portions of data. For example, text data can be assigned a higher priority than image data. A client device can receive information regarding priority and selectively display the portions of data in accordance with their priorities. For example, the document in displayable format can be displayed with the portions having the highest priority. In this example, a user can select to display the portions having the lower priority that are contained in the supplemental data. The display can be configured to display only the lower priority portions and/or the high priority portions. This feature can be advantageous, for example, when displaying a web document on a device having a small display screen (e.g., a smartphone). The higher priority portions of the web document can be included in the document in displayable format for only displaying the portions deemed to have a higher priority. A user can select to display the lower priority portions of the web document. The data can be command results.

In another embodiment, a client device can communicate a command to a server. The command can include search terms for conducting a query. The server can communicate the search terms to a search engine for retrieving search results. The server can receive the search results from the search engine and communicate the search results to the client device in a document in displayable format. The server can also determine other related search terms, which can be predictive search terms, and communicated the related search terms to the search engine or another search engine for retrieving predictive search results. The predictive search results can be communicated to the client device in the document in displayable format, another document in displayable format, and/or invisible data. Alternatively the predictive search results can be sent to a network server. A user can access and/or display the supplemental data including the predictive search results as described herein.

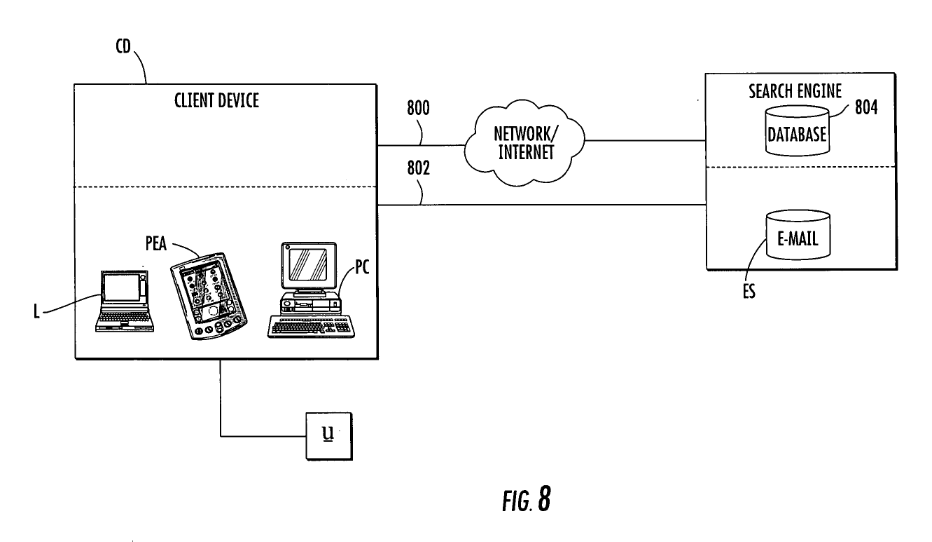

FIG. 8 is a block diagram of another example of method and system for providing search results to a client device according to an aspect of the subject mailer described herein. Referring to FIG. 8, user U can utilize client device CD for communicating with a search engine SE. Client device CD can include or be any suitable client device, such as for example a desktop computer PC, a laptop computer L or a portable electronic apparatus PEA which can be a PDA, a smartphone, or another type of electronic portable apparatus. Communication from client device CD with search engine SE can, for example, be in the form of a user request from a user U through client device CD. Such communication can occur in any suitable manner, such as for example through a networked connection such as an network connection 800 where client device CD and search engine SE can communicate through a communication session while connected to a network such as the Internet. Instead or in addition to the above, communication from client device CD with search engine SE can be, for example, in the form of any suitable direct connection between client device CD with search engine SE as shown by direct connection 802. This type of connection can include a direct communication session established other than through an Internet connection. Direct connection 802 can, for example, include or be a serial connection for communication, an e-mail communication, text messaging communication, a secured Internet connection or any other type of communication. Search engine SE can include suitable electronic processing components such as a database 804. Search engine SE can also include or be in communication with an e-mail server ES which can be used for e-mail communication.

Whether network connection 800 is used or direct a connection such as direct connection 802 is used, user U can through client device CD communicate a user request to search engine SE. The user request can include or be for any suitable information. For example, the user request can include or be a search query from user U. Also and in addition to or in lieu of the above, the user request can include or be instructions for the search engine to perform some task. User requested instructions can, for example, cause search engine SE to send requested data to user U through communication with client device CD. The requested data can include or be a data file that can relate to information, such as a search query. Such a data file can be generated by search engine SE by the user request triggering search engine SE to perform an information lookup using database 804 or to conduct a comparison of information from the user request with other information that is part of or accessible by search engine SE. User requested instructions can, for example, cause search engine SE to perform a task such as to conduct or run a search on search engine SE, which can be a search using database 804.

When search engine SE sends or communicates back with client device CD, the communication can again be through network connection 800 and/or through direct connection 802. For example, when the user request includes instructions for search engine SE to communicate information back to client device CD, the communication can be via an e-mail message from search engine SE that can use e-mail server ES. The e-mail message can contain information from search engine SE requested by user U. Regardless of how search engine SE communicates with client device CD, it can be seen therefore that user U can obtain information from search engine SE through client device CD. For example, user U can use client device CD to communicate with search engine SE to conduct an original search query, and a first set of search results based upon the original search query can be sent from search engine SE back to user U through client device CD.

In addition to the above, information sent from search engine SE to user U through client device CD can in accordance with the present subject matter include data from search engine SE that may or may not have been specifically requested and that can pertain to the user request from the initial communication from user U to search engine SE. This additional data can, for example, comprise data for conducting additional searches based upon an initial search query. The additional searches can though advantageously be conducted by user U locally on or using client device CD without the need for a continued or additional communication session with search engine SE. The additional data, or supplemental data, can by way of example be sent from search engine SE to client device CD along with a first set of search results and during a communication session from either a networked or direct connection.

User U can cause search engine SE to generate and send back to user U a first set of search results pertaining to a user request such as a search query wherein user U can at that time or at a separate time also cause search engine SE to send, using network connection 800 or direct connection 802, the supplemental data to user U through client device CD. User U can therefore receive a first set of search results during some type of communication session with search engine SE, and then user U can, without being in communication with search engine SE, use the supplemental data to generate, such as on client device CD, a subsequent set of search results that can be based upon the first set of search results. The subsequent set of search results can, for example, be generated by user U conducting on client device CD additional or different searches using the supplemental data. As described with other aspects previously, the supplemental data can include any suitable information and can include search data relevant to the first search data, such as predictive search data.

In one example of the subject matter described herein, a user can input a search query into a PDA for searching for web documents related to the search query. For example, the search query can include search terms. The PDA can communicate the search query to a search engine via a network connection. The PDA can communicate the search query via a WiFi or cellular connection and the Internet. The search engine can receive the search query and conduct a search of web documents cached by the search engine. The search can be based on the search terms. The search engine can determine identifiers (e.g., URLs) for web documents deemed relevant to the search terms by using a suitable search algorithm. The search engine can generate a document in displayable format that includes the web document identifiers and communicate the document to the PDA. The PDA can display the document. Further, the search engine can access the Internet for obtaining web documents based on the identifiers. The search engine can generate supplemental data including the web documents accessed on the Internet. The web documents accessed on the Internet can correspond to the documents that are accessible by the identifiers in the document in displayable format. The supplemental data can be communicated to the client device and stored by the client device. A user of the client device can select one of the identifiers for displaying a web document. In response to selection of one of the identifiers, client device can access the stored supplemental data for obtaining the selected web document and display the selected web document on a display of the client device. By using this technique, client device does not have to establish another network connection to obtain the selected web document.

In another example of the subject matter described herein, a user can input equipment control commands into a PDA for controlling equipment remote from the PDA. The PDA can communicate an equipment control command to the equipment via a network connection. The PDA can communicate the command via a WiFi or cellular connection and the Internet. The equipment can receive the command and implement the command. The search engine can generate a document in displayable format that includes results of implementing the command and communicate the document to the PDA. The PDA can display the document with a display device. Further, the equipment can generate monitoring data related to the command and generate supplemental data including the monitoring data. The supplemental data can be communicated to the client device and stored by the client device. A user of the client device can input a request for monitoring data associated with the equipment. In response to receiving the request, client device can access the stored supplemental data for obtaining the requested data and display the requested data via the display device. By using this technique, client device does not have to establish another connection with the equipment to obtain the requested monitoring data.

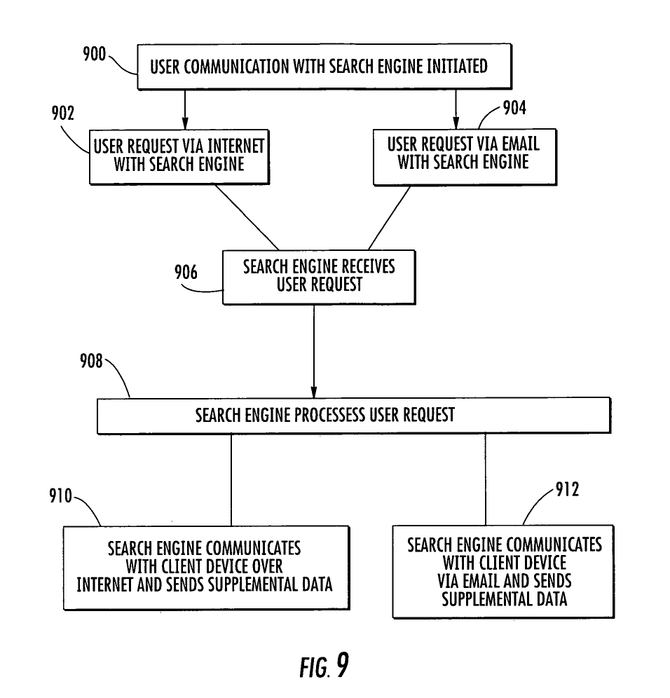

FIG. 9 is a flow chart providing additional examples of possible applications using a network in accordance with the present disclosure, including but not limited to a network such as that illustrated in FIG. 8. Referring to block 900 of FIG. 9, a user can through any suitable client device communicate during a communication session with a search engine. The communication session can be an online session such as in block 902 over a network such as the Internet between the client device and the search engine. The communication session can also be a communication session via e-mail as in block 904 where the user using the client device can send an e-mail to the search engine to cause some action as described further below. Any other suitable type of communication session could also be utilized. During whatever type of communication session is used, the user can communicate with the search engine. During the communication session, whether over the Internet or via e-mail communication, the search engine can receive a user request as in block 906.

At block 908, the search engine can then process the user request. Where the user request comprises a search query communicated over the Internet or through any other communication session, the search engine can conduct the search query and provide results back to the client device. Where the user request comprises some request other than a search query, the search engine can carry out the user request and communicate back with the client device. As mentioned previously, the user request can include instructions for the search engine to perform some type of task. Such as user request can include or be, for example, instructions for the search engine to perform a search query and e-mail, then or later, the results to the client device. The user request could also be, for example, instructions for the search engine to simply e-mail some data, then or later, to the client device without having to perform a search query. The data sent could be saved or compiled data in some database of the search engine or otherwise accessible to the search engine.

Communication from the search engine back to the client device can be over a network such as the Internet as in block 910, or through any other communication session, such as, for example, an e-mail communication session with client device as in block 912. Communication from the search engine back to the client device can include supplemental data that can be responsive to a search query from the user request or can be related to instructions from the user request. For example, in addition to the search engine automatically sending supplemental data to the client device along with search results from a search query, where the existence of the supplemental data may be unknown or known to a user, a user through a client device can also specifically request that supplemental data, by itself or along with other data, be communicated to the client device. Also, it can be seen that a user can also use e-mail communication to obtain search results along with supplemental data from a search engine or to cause the search engine to obtain requested data responsive to instructions in a user request and then communicate back to the user the requested data along with or only with supplemental data.

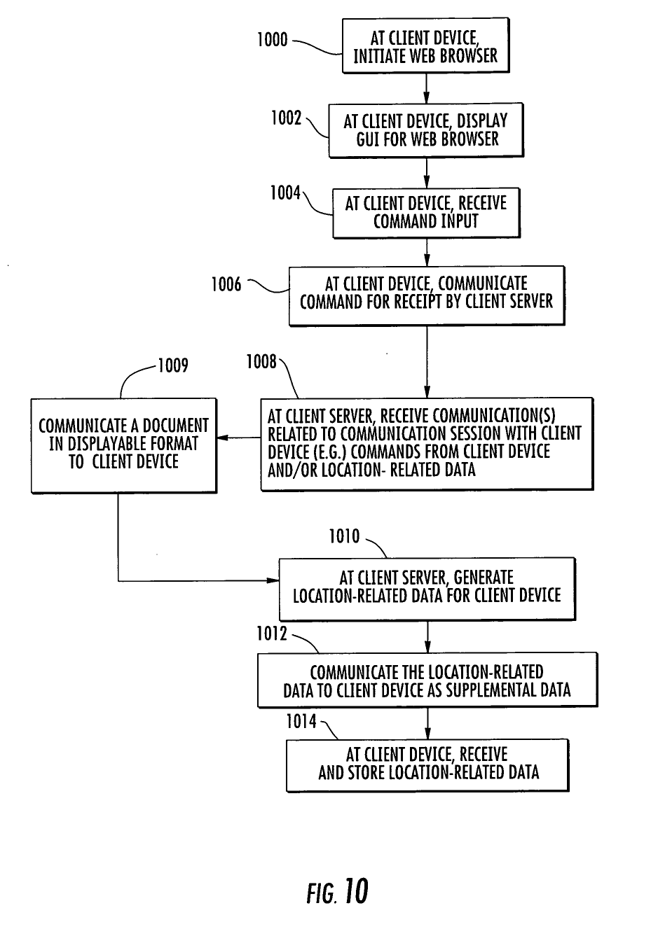

According to one embodiment, supplemental data can include location-related data. In one example, the location-related data can be communicated to a client device in response to the client device communicating a command to a client server. In another example, the location-related data can be communicated to a client device having a subscription to services provided by a client server. FIG. 10 is a flow chart illustrating an example of a process for providing location-related data to a client device according to an aspect of the subject matter described herein. In this example, reference is made to the components shown in FIG. 1. In block 1000 of FIG. 10, user U can enter input into input interface INP for initiating web browser WB. Web browser WB can be initiated and display a GUI on output interface INT for user interaction (block 1002).

The GUI of client device CD can receive command input for communication to client server CS (block 1004). The command input can be any suitable type of communication for initiating a communication session with client server CS. For example, the command input can be a search query including search terms for use in searching web documents accessible by client server CS. In another example, the command input can be a command for displaying a web page provided by client server CS to the Internet. Client device CD can communicate the command for receipt by client server CS (block 1006).

The initial or any other subsequent communication sent to client server CS by client device CD can include a request for location-related data. Alternatively, none of the communications from client device CD can include a request for location-related data. Further, any communication sent to client server CS with respect to client device CD may include positioning-related data. For example, the positioning-related data can be any suitable data that can be utilized by client server CS for determining a position of client device CD. For example, the positioning-related data can include satellite positioning data, such as global positioning system (GPS) data. In this example, the satellite positioning data may be positioning data obtained by a positioning component resident on client device CD or in communication with client device CD. In another example, positioning-related data can be obtained from any various tracking systems, such as roadside posts that can identify a position and communicate the position to a client device. In another example, client device CD can receive the data regarding a position of client device CD from a networking component that is an intermediary for communicating information between client device CD and client server CS. For example, client server CS can determine the location of client device CD if communications from client device CD are received from a network component in which the position of the network component can be determined from received messages. In this example, client server CS may at least be able to determine a general location of client device CD because communications, such as messages, could be examined for information identifying a network component that has a known location. For example, the position of a cell phone tower may be known based on communications from the cell phone tower. In this example, the general location of a client device using the cell phone tower would be known based on messages received from the client device through the cell phone tower.

Client server CS may receive one or more communications related to the communication session with client device CD (block 1008). For example, client server CS may receive command communications from client device CD. Further, for example, client server CS may include location-related data from client device CD or any other suitable network component that provides information in communicated messages that identify a location of client device CD, either generally or specifically.

Client server CS can communicate to client device CD a document in displayable format including information related to communications with client device CD. For example, the document in displayable format can include search results based on a search query received from client device CD.

In response to the communication session with client device CD, client server CS can generate location-related data for client device CD (block 1010). Exemplary location-related data includes a map of roads in the vicinity of a position of client device CD, identification of one or more restaurants and restaurant locations near a position of client device CD, identification of road traffic and road traffic location near a position of client device CD, identification of news corresponding to locations near a position of client device CD, identification of weather corresponding to locations near a position of client device CD, and any other suitable data related to a position of client device CD. The position-related data may be stored on client server CS or obtained by client server CS via a network. For example, client server CS may use the position-related data of client device CD, preferences associated with client device CD, and/or any other information associated with client device CD for searching the Internet for location-related data.

In block 1012, client server CS can communicate the location-related data to client device CD as supplemental data. The location-related data can be communicated to client device CD at any time during the communication session with client device CD or on establishment of another communication session with client device CD.

In block 1014, client server CS can receive and store the location-related data. The location-related data can be received and stored in accordance to the subject matter described herein for receiving and storing supplemental data. For example, the location-related data can be stored on client device CD and subsequently retrieved, during or outside of a communication session, in response to a request for the location-related data by input of user U. In response to the request, the GUI of output interface OTPT can display the location-related data. For example, the GUI can display a map of roads, a map of restaurants, and any other received location-related data. The receipt and storage of location-related data without user request can be advantageous, for example, when client device CD is a smartphone and user leaves a wireless service area. In this example, the most recently available location-related data would be available on the smartphone even without a user request for the data.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing command results, the method comprising:
(a) receiving a command from a client device;
(b) retrieving command results based on the command;
(c) communicating to the client device a document in a displayable format and including a first portion of the command results; and
(d) communicating to the client device supplemental data including a second portion of the command results.

2. The method of claim 1 wherein the command includes a search query.

3. The method of claim 1 wherein the first and second command results include data stored on a network.

4. The method of claim 3 wherein the network includes the Internet.

5. The method of claim 1 wherein the first command result includes web document information.

6. The method of claim 1 wherein the first and second command results include data related to commercial products.

7. The method of claim 1 comprising communicating computer-readable instructions to the client device for displaying at least a portion of the second command result.

8. The method of claim 7 comprising receiving, at the client device, user input for executing the computer-readable instructions for displaying the at least a portion of the second command result.

9. The method of claim 8 comprising displaying, at the client device, the at least a portion of the second command result.

10. The method of claim 1 comprising communicating computer-readable instructions to the client device for filtering at least a portion of the second command result.

11. The method of claim 10 comprising receiving, at the client device, user input for executing the computer-readable instruction for filtering the at least a portion of the second command result.

12. The method of claim 11 comprising, displaying, at the client device, the at least a portion of the second command result.

13. The method of claim 10 wherein the computer-readable instructions include computer-readable instructions for one of filtering the second command result by a category, filtering the second command result by a date of creation or modification, filtering the second command result by text content, and filtering the second command result by image data content.

14. The method of claim 1, wherein the command is a search query, and the method comprises retrieving predictive search criteria based on the search query or based on the first search result, and wherein retrieving first and second search results includes retrieving the second search result based on the predictive search criteria.

15. The method of claim 1 comprising communicating, to the client device, an executable including instructions for displaying the second command result.

16. The method of claim 15 comprising executing the instructions of the executable for displaying the second command result.

17. The method of claim 15 wherein the second command result includes a plurality of command results, and comprising communicating an executable including instructions to the client device for filtering the plurality of command results.

18. The method of claim 1 wherein the document is displayable on a graphical user interface (GUI) by a web browser of the client device.

19. The method of claim 18 comprising automatically displaying, at the client device, the document in response to receiving the document.

20. The method of claim 1 wherein retrieving the first and second command results includes retrieving the first command result prior to retrieving the second command result, and wherein communicating to the client device a document in a displayable format includes communicating the document to the client device in response to retrieving the first command result.

21. The method of claim 20 wherein the second command result includes a plurality of command results, wherein the supplemental data includes a plurality of files, and comprising communicating to the client device the plurality of files after communicating the document to the client device.

22. The method of claim 21 wherein communicating to the client device the plurality of files includes communicating to the client device each of the plurality of files in separate communications.

23. The method of claim 1 wherein the command is a search query, wherein the search query is a first search query, and wherein the method comprises receiving, at the client device, a second search query for search the second search result.

24. The method of claim 1 wherein the client device comprises a computer, a personal digital assistant (PDA), and/or a mobile phone.

25. The method of claim 1 wherein communicating to the client device the document includes communicating to the client device the document via the Internet.

26. The method of claim 1 wherein the document includes a hypertext markup language (HTML) document.

27. The method of claim 1 wherein communicating to the client device the supplemental data includes communicating to the client device the document via the Internet.

28. The method of claim 1 wherein the supplemental data includes a data file, a text file, a program file, and/or a-directory file.

29. The method of claim 1 wherein communicating to the client device supplemental data comprises:
(a) storing the supplemental data at a network component;
(b) at the network component, receiving a request from the client device for communicating the supplemental data to the client device; and
(c) in response to receiving the request, communicating the supplemental data to the client device.

30. The method of claim 1 wherein the first portion of the command results has a higher priority than the second portion.

31. A system for providing command results, the system comprising:
(a) a network interface operable to receive a command from a client device;
(b) a command function configured to retrieve command results based on the command;
(c) a document generator configured to generate a document in a displayable format and including a first portion of the command results for communication to the client device; and
(d) an supplemental data generator configured to generate supplemental data including a second portion of the command results for communication to the client device.

32. A computer program product comprising computer-executable instructions embodied in a computer-readable medium for performing steps comprising:
(a) receiving a command query from a client device;
(b) retrieving command results based on the command;
(c) communicating to the client device a document in a displayable format and including a first portion of the command results; and
(d) communicating to the client device supplemental data including a second portion of the command results.

33. A method for retrieving search results, the method comprising:
(a) communicating a search query to a server;
(b) receiving, from the server, a document in a displayable format and including a first search result; and
(c) receiving, from the server, a file including a second search result.

34. The method of claim 33 comprising displaying the document including the first search result.

35. The method of claim 33 wherein displaying the document including the first search result includes automatically displaying the document including the first search result.

36. The method of claim 33 comprising:
(a) receiving a user request to-display the second search result; and
(b) in response to receiving the user request, displaying the second search result.

37. The method of claim 33 comprising receiving, from the server, an executable including instructions for displaying the second search result.

38. The method of claim 37 wherein the second search result includes a plurality of search results, and comprising receiving, from the server, an executable including instructions for filtering the plurality of search results.

39. A device for retrieving search results, the system comprising:
(a) an input interface operable to receive a command input from a user; and
(b) a command communicator configured to:
(i) communicate a search query to a server;
(ii) configured to receive, from the server, a document in a displayable format and including a first search result; and
(iii) receive, from the server, a file including a second search result.

40. A computer program product comprising computer-executable instructions embodied in a computer-readable medium for performing steps comprising:
(a) communicating a search query to a server;
(b) receiving, from the server, a document in a displayable format and including a first search result; and
(c) receiving, from the server, a file including a second search result.

41. A method for providing search results to a client device, the method comprising:
(a) receiving user search criteria from a client device;
(b) retrieving a first search result based on the user search criteria;
(c) determining predictive search criteria based on the user search criteria or based on the first search result;
(d) retrieving a second search result based on the predictive search criteria; and
(e) communicating the first and second search results to the client device as supplemental data.

42. The method of claim 41 wherein communicating the first and second search results to the client device includes automatically communicating the first and second search results together to the client device.

43. The method of claim 41 comprising communicating the predictive search criteria to the client device.

44. A system for providing search results to a client device, the system comprising:
(a) a network interface configured to receive user search criteria from a client device;
(b) a command function configured to retrieve a first search result based on the user search criteria;
(c) an supplemental data generator configured to:
(i) determine predictive search criteria based on the user search criteria or based on the first search result;
(ii) retrieve a second search result based on the predictive search criteria; and
(iii) communicate the first and second search results to the client device as supplemental data.

45. A computer program product comprising computer-executable instructions embodied in a computer-readable medium for performing steps comprising:
(a) receiving user search criteria from a client device;
(b) retrieving a first search result based on the user search criteria;
(c) determining predictive search criteria based on the user search criteria or based on the first search result;
(d) retrieving a second search result based on the predictive search criteria; and
(e) communicating the first and second search results to the client device as supplemental data.

46. A method for providing internet search results, the method comprising:
(a) generating a first set of search results during a communication session and communicating the first set of search results to a user; and
(b) outside of the communication session, generating at least one subsequent set of search results based upon the first set of search results by applying search data to the first set of search results, wherein the search data comprises data relating to the first set of search results.

47. The method of claim 46 wherein the first set of search results is produced from a search query conducted by the user on a search engine during the communication session.

48. The method of claim 46 wherein the first set of search results comprises search results communicated to the user in an e-mail message during the communication session.

49. The method of claim 48 wherein the first set of search results is communicated to the user by the e-mail message based upon a user request for the first set of search results.

50. The method of claim 47 wherein the search data comprises saved information previously obtained during a communication session.

51. The method of claim 46 wherein the search data comprises saved information previously communicated to the user via an e-mail message.

52. The method of claim 46 wherein the search data comprises saved information provided with the first set of search results.

53. The method of claim 52 wherein the search data comprises saved information provided invisibly along with providing the first set of search results.

54. The method of claim 53 wherein the search data provided invisibly with the first set of search results comprises filtering data for filtering the first set of search results.

55. The method of claim 46 wherein the search data comprises predictive search information previously determined to be relevant to the first set of search results.

56. The method of claim 46 wherein the search data comprises one or more executable files.

57. The method of claim 46 wherein the search data comprises a data file that relates to a search query used to produce the first set of search results.

58. The method of claim 57 wherein the data file comprises information specifically relating to the search query.

59. The method of claim 57 wherein the data file is produced from a comparison of the search query to an information database.

60. The method of claim 46 wherein the search data comprises filtering data for filtering the first set of search results.

61. The method of claim 46 wherein the search data comprises predictive data regarding the first set of search results.

62. A method for providing internet search results, the method comprising:
(a) submitting a search query to a search engine;
(b) receiving from the search engine a first set of search results along with search data pertaining to the search results;
(c) conducting additional searching regarding the first set of search results by applying offline the search data to the first set of search results.

63. The method of claim 61 further comprising determining what the search data will be prior to step (b).

64. The method of claim 63 wherein determining what the search data will be comprises providing predictive search data relating to the search query.

65. A system for providing Internet search results, the system comprising:
(a) a client device usable by a user for sending a data request for a first set of search results during a communication session;
(b) a search engine for receiving the data request from the client device during the communication session and for sending the first set of search results to the client device; and
(c) the search engine being configured for communicating search data to the client device wherein the search data comprises data relating to the first set of search results for conducting further searching based upon the first set of search results outside of a communication session between the client device and the search engine.

66. A method for providing location-related data, the method comprising:
at a search engine:
(a) receiving a search query from a client device;
(b) determining location-related data based on the search query;
(c) communicating to the client device a document in a displayable format and including a search results based on the search query; and
(d) communicating to the client device supplemental data including the location-related data based on the search query.

67. The method of claim 66 comprising receiving position-related data associated with the client device.

68. The method of claim 67 wherein determining location-related data includes determining the location-related data based on the position-related data associated with the client device.

69. The method of claim 67 wherein the client device comprises a computer, a personal digital assistant (PDA), and/or a mobile phone.
